(19) United States
(12) Patent Application Publication
(10) Pub. No.: US 2020/0133387 A9
(43) Pub. Date: Apr. 30, 2020

(54) SYSTEM FOR DETECTING FACIAL MOVEMENTS OVER A FACE OF A USER

(71) Applicant: Silicon Algebra Inc., Saratoga, CA (US)

(72) Inventors: Kevin Lee, Saratoga, CA (US); Ivan Roberto Reyes, Redmond, WA (US); John P. Pella, Redmond, WA (US); Quentin DeWolf, Seattle, WA (US)

(21) Appl. No.: 15/989,113

(22) Filed: May 24, 2018

Related U.S. Application Data
(60) Provisional application No. 62/510,651, filed on May 24, 2017.

(51) Int. Cl. G06F 3/01; A63F 13/212; A63F 13/213

(52) U.S. Cl. CPC G06F 3/012; A63F 13/213; A63F 13/212; G06F 3/017

(57) ABSTRACT

A system for detecting facial movements of a user includes: a sensor assembly including: an elastic member 110 configured to couple to a headset and contact a face of a user, proximal and offset from ocular regions of the face of the user and a substrate that defines a set of discrete electrical channels and a set of electrode tabs distributed along the elastic member, wherein each electrode tab is configured to proximally contact a muscular region on the face of the user; and a controller configured to sample a set of sense signals from the set of electrode tabs via the set of discrete electrical channels and to interpret changes in the set of sense signals over time as expressions on the face of the user when the headset is worn by the user.

### CROSS-REFERENCES TO RELATED APPLICATIONS

This application claims the benefit of U.S. Provisional Application No. 62/510,651, filed on 24 May 2017, which is incorporated in its entirety by this reference.

### TECHNICAL FIELD

This invention relates generally to the field of biometric sensors and more specifically to a new and useful system for detecting facial movements over a face of a user in the field of biometric sensors.

### BRIEF DESCRIPTION OF THE FIGURES

FIG. 1 is a schematic representation of a system;

FIG. 2 is a schematic representation of one variation of the system;

FIGS. 3A and 3B are schematic representations of one variation of the system;

FIG. 4 is a flowchart representation of one variation of the system;

FIG. 5 is a flowchart representation of one variation of the system;

FIG. 6 is a schematic representation of one variation of the system;

FIG. 7 is a flowchart representation of one variation of a first method; and

FIG. 8 is a flowchart representation of one variation of a second method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. System and Method

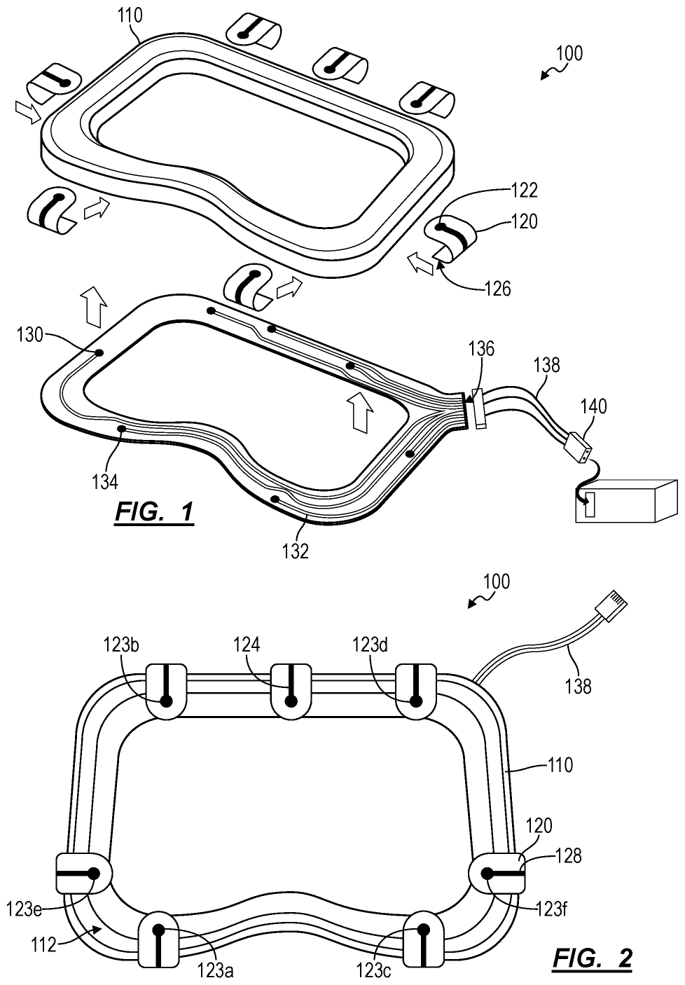

As shown in FIGS. 1 and 2, a system for detecting facial movements over a face of a user obscured by a headset includes: a sensor assembly that includes: an elastic member 110: configured to couple to a headset and contact a face of a user, proximal and offset from ocular regions of the face of the user, when the headset is worn by the user, and wherein the elastic member is composed of a compressible material configured to conform to the face of the user when the headset is worn by the user. The sensor assembly also includes a substrate arranged across an exterior surface of the elastic member that defines a set of discrete electrical channels. The sensor assembly further includes a set of electrode tabs distributed along the elastic member, wherein each electrode tab is configured to proximally contact a muscular region on the face of the user when the headset is worn by the user and wherein each electrode tab includes a sense electrode that defines an electrical contact surface facing outwardly from an interior surface of the elastic member opposite the substrate. Each electrode tab is further configured to contact skin on the face of the user when the headset is worn by the user; and further includes an enclosed trace extending from the sense electrode at the interior face of the elastic member to a discrete electrical channel, in the set of discrete electrical channels, at the exterior face of the elastic member. In addition to the sensor assembly, the system also includes a controller configured to sample a set of sense signals from the set of electrode tabs via the set of discrete electrical channels and to interpret changes in the set of sense signals over time as expressions on the face of the user when the headset is worn by the user.

As shown in FIG. 6, in one variation of the system, the elastic member is coupled to the headset, which is a pair of optical glasses; and the elastic member is configured to contact the face of the user, proximal to supraorbital regions of the face of the user and offset from ocular regions of the face of the user, when the headset is worn by the user. The variation of the system further includes a second elastic member configured to contact a nasal bridge region of the face of the user and offset from ocular regions of the face of the user, when the headset is worn by the user. The variation of the system also includes a second set of the electrode tabs distributed along the second elastic member. In this variation of the system, the controller is configured to sample a second set of sense signals from the second set of electrode tabs and to interpret changes in the first set of sense signals and the second set of sense signals over time as expressions on the face of the user when the headset is worn by the user.

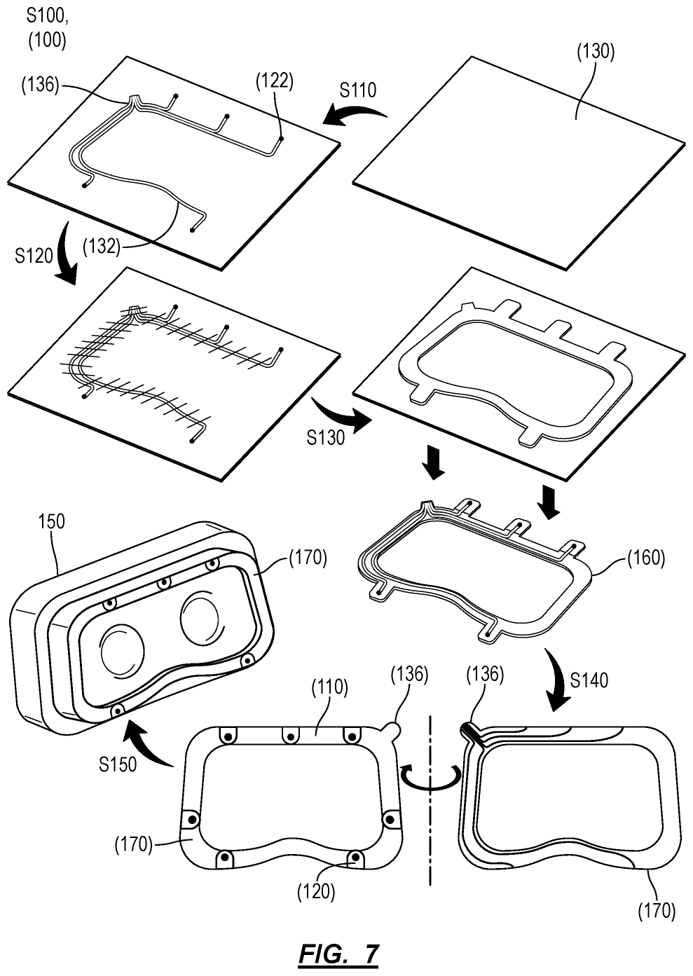

As shown in FIG. 7, a first manufacturing method S100 includes applying a layer of conductive ink to an exterior surface of a flexible substrate to form: a set of sense electrodes, a common junction, and a set of electrical traces, wherein each electrical trace connects each sense electrode in the set of sense electrodes to a corresponding electrical channel of the common junction in Block Silo. The first manufacturing method also includes applying a non-oxidative conductive layer over the set of sense electrodes and applying a nonconductive cover layer over the set of electrical traces 128 in Block S120. The first manufacturing method further includes selectively cutting the flexible substrate around the applied layer of conductive ink to define: a substrate ring comprising the set of electrical traces 128 and the common junction, and a set of electrode tabs extending radially from the substrate ring, each electrode tab in the set of electrode tabs comprising a sense electrode in the set of sense electrodes in Block S130. The first manufacturing method also includes assembling a sensor assembly by adhering: an interior surface of the substrate ring to an exterior surface of an elastic member configured to conform to a face of a user offset from the ocular regions of the face of the user, and an interior surface of each in the set of electrode tabs to an interior surface of the elastic member in Block S140. The first manufacturing method also includes applying an adherent to an exterior surface of the sensor assembly, wherein the adherent is configured to transiently couple the sensor assembly to a view window of a virtual reality headset in Block S150.

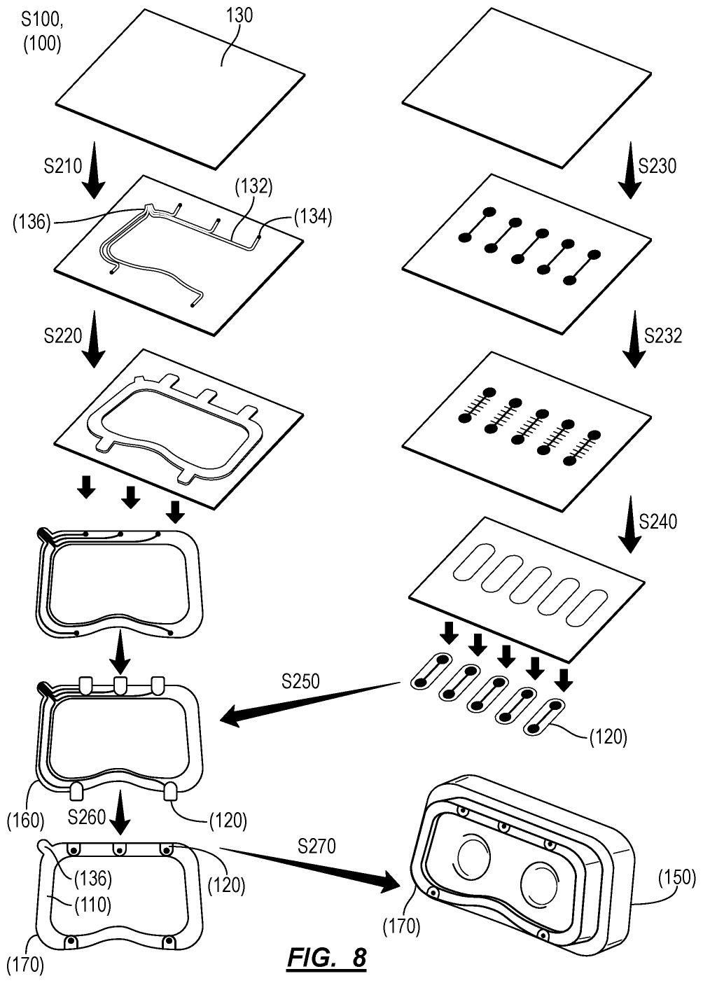

As shown in FIG. 8, a second manufacturing method S200 includes applying a layer of conductive ink to an exterior surface of a flexible substrate to form: a common junction, a set of electrical pads, and a set of electrical channels, wherein each electrical channel connects each electrical pad in the set of electrical pads to a corresponding electrical channel of the common junction in Block S210. The second manufacturing method also includes selectively cutting the flexible substrate around the applied layer of conductive ink to define a substrate ring comprising the set of electrical pads, the set of electrical channels, and the common junction in Block S220. The second manufacturing method further includes applying a layer of conductive ink to a flexible polymer sheet to form a set of electrode tabs, each electrode tab including: a junction pad, a sense electrode, and, an electrical trace connecting the junction pad and the sense electrode in Block S230. The second manufacturing method also includes, for each electrode tab in the set of electrode tabs, separating the electrode tab from the flexible polymer sheet in Block S240. The second manufacturing method also includes assembling an electrode-substrate assembly by adhering, for each electrode tab in the set of electrode tabs, the junction pad of the electrode tab to an electrical pad in the set of electrical pads on the substrate ring S250. The second manufacturing method also includes assembling a sensor assembly by adhering: an interior surface of the substrate ring of the electrode-substrate assembly to an exterior surface of an elastic member configured to conform to a face of a user offset from the ocular regions of the face of the user; and an interior surface of each electrode tab in the set of electrode tabs to an interior surface of the elastic member in Block S260. The second manufacturing method also includes applying an adherent to an exterior surface of the sensor assembly, the adherent configured to transiently couple the sensor assembly to a view window of a virtual reality headset in Block S270.

### 2. Applications

Generally, the system 100 includes: an elastic member 110 (or “gasket”), a substrate 130, and a set of sense electrodes and/or reference electrodes 124 that together form a passive sensor assembly 170; and a controller 140 (and signal processing circuitry) arranged remotely from the sensor assembly 170 that can be configured to interpret signals read from the sensor assembly 170 as facial expressions of a face in contact with the sensor assembly 170. In particular, the elastic member or members 110 or define a soft, flexible (e.g., foam) gasket or series of pads configured to transiently or permanently install around a view window of a headset (e.g., around a display of a virtual reality headset), to be pressed against the user's face by the (rigid) view window of the headset, and to conform to the user's face when the (rigid) headset is worn over the user's eyes and face, thereby improving the user's comfort when wearing the headset and sealing the junction between the headset and the user's face from light ingress and egress. In one variation, the gasket can be implemented as a discontinuous set of pads attached to a pair of ocular glasses. In this variation, the weight of the optical glasses can hold the gaskets against the skin of a user at the bridge of the user's nose and at the user's temple above the user's eyes. The set of passive electrodes 122 are distributed across the interior surface of the elastic member or members 110 and face opposite the headset such that these electrodes 122 contact the user's skin at proximal target (muscular) locations on the user's face when the headset is worn by the user; these electrodes 122 are each electrically coupled to discrete electrical channels 132 (or “traces”) on the substrate 130 and arranged across the exterior surface of the elastic member 110, each of which is electrically coupled to the controller 140, such as via a wire or flexible PCB. If the gaskets are instead attached to a pair of optical glasses, the discrete electrical traces 128 can be incorporated into a substrate 130 within the frame of the glasses.

The controller 140 is configured to read electromyography (or “EMG”) signals—indicative of muscle movements and therefore expressions or expression changes on the user's face—from sense electrodes 123 in contact with regions of the user's face while the headset is worn by the user. Additionally, the controller 140 can read electrical signals generated by sense electrodes 123 moving across the surface of a user's skin as the user changes expression. The controller 140 can then process these signals (e.g., changes in these signals over time) to compute expressions or transitions between expressions on a user's face, such as by passing voltage potentials read from these sensors over a sequence of sampling periods into a neural network (e.g., a long short-term memory recurrent neural network). The controller 140 can then return values for these expressions to a gaming console or other computing device that can update a virtual avatar—representing the user within a virtual environment—to embody these expressions substantially in real-time. In some variations of the system, the values representing a user's expression can be applied to other media, such as a text or audio message to “tag” the media with an emotion. For example, a media tag could indicate that a user was smiling while dictating a message into a pair of smart optical glasses or goggles integrated with the system 100. In some variations of the system 100, the controller 140 can return values to a headset indicating whether, and to what degree, the user is squinting. The controller 140, or another processing unit in the headset, can then adjust the brightness of the screen, or adjust the opacity of the lenses, in the case of a pair of optical glasses or goggles, to reduce the amount of light incident to the user's eyes.

Therefore, the system 100 can be integrated into or installed in a headset (e.g., a virtual reality head-mounted display headset, a pair of ski goggles, a pair of optical glasses, etc.) to detect facial expressions of a user wearing the headset by directly reading voltage potentials on the user's face through a small number of passive electrodes 122, correlating these voltage potentials with muscle movements, and interpreting these muscle movements as facial expressions (e.g., rather than remotely sensing the user's face, which may be visually obstructed by the headset).

In some variations of the system 100, the sensor assembly 170 (including the electrodes 122, substrate 130, and electrical traces 128) are separable and remote from the controller 140 and replaceable with a second sensor assembly 170. Because the gasket is designed to contact the user's skin, oxidation and wear may occur across these electrodes 122 during use on the sensor assembly 170; the sensor assembly 170 can therefore be fabricated with materials described herein and according to the manufacturing method S200 described below in order to limit total cost of the sensor assembly 170 such that the sensor assembly 170 may be conveniently replaced once oxidization has sufficiently inhibited function of the electrodes 122. In one example, the sensor assembly 170 is manufactured by printing conductive ink onto a flexible substrate 130 to define a series of electrodes 122, electrical channels 132, and a common junction 136 on the surface of the flexible substrate 130. In this example, a single component defines all the electrical components of the sensor assembly 170. Then the unitary structure defining the electrical components is adhered to the elastic member 110 in a single step, thereby reducing manufacturing costs.

In another example, the common junction 136, electrical channels 132, and electrical pads 134 are printed onto a substrate 130 which is then selectively cut from the substrate 130 to define a substrate ring. Electrode tabs 120 are printed and cut from a separate flexible polymer sheet and adhered to radially extend from the substrate ring before being adhered to the elastic member 110. In this variation, the substrate ring can be manufactured from a lower cost substrate 130 than the electrode tabs 120, thereby reducing cost of the sensor assembly 170.

The system 100 includes electrode tabs 120, which define structural elements configured to position electrodes in contact with a user's face when the headset is worn by the user. In some implementations, one subset of the electrode tabs 120 define sense electrode tabs, and a second subset of the electrode tabs define reference electrode tabs. While the sense electrode tabs and the reference electrode tabs may be both structurally consistent with electrode tabs 120 in general, they may differ in their positioning along the elastic member 110 and thus function to read either sense or reference signals from the user's skin. Therefore, structural descriptions of electrode tabs 120 below can apply to both sense electrode tabs and reference electrode tabs. Similarly, in some implementations, electrodes 122 can be divided into two subsets, including sense electrodes 123 and reference electrodes 124. Like sense electrode tabs and reference electrode tabs, sense electrodes 123 and reference electrodes 124 can be structurally similar but can differ in their location on the elastic member 110 and how the controller processes signals received from each type of electrode. Therefore, structural descriptions of electrodes 122 below can apply to both sense electrodes 123 and reference electrodes 124.

The system 100 is described with reference to particular applications, including: the system 100's integration with a VR headset; and the system 100's integration with a pair of optical glasses or goggles. However, the system 100 can be integrated into a wearable or other computing device of any other type or form, and the controller can implement any other methods or techniques to interpret a facial expression of a user wearing the device based on sense and/or reference signals read by sense and/or reference electrode tabs integrated into the system 100.

### 3. Headset and Integration

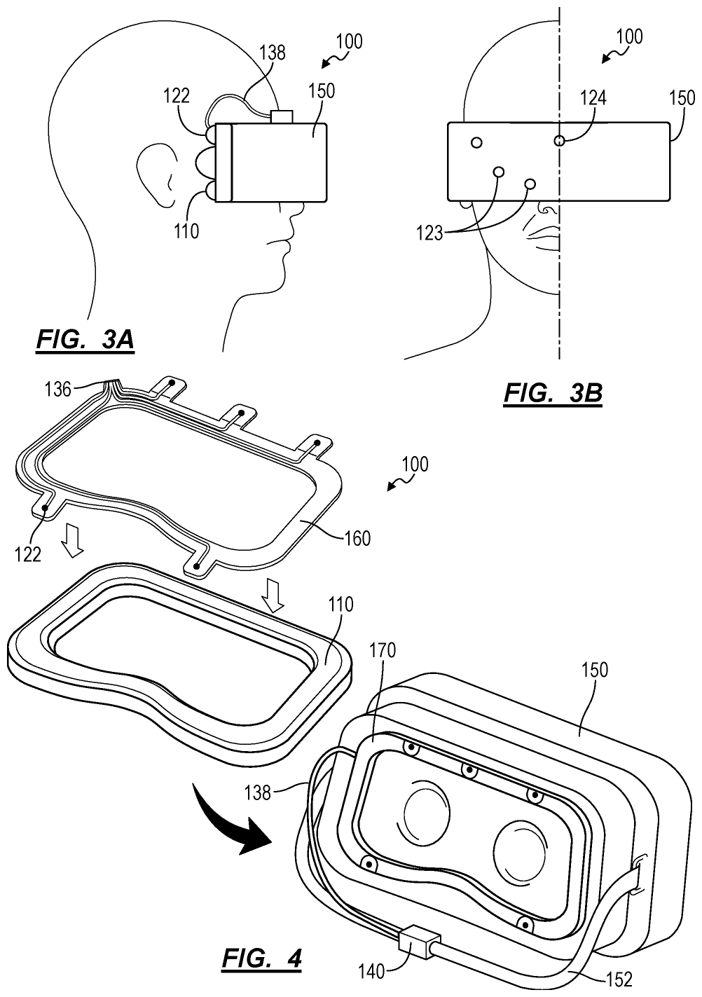

As shown in FIGS. 3A and 3B, the system 100 can be configured to physically interface with an augmented or virtual reality (or “VR”) headset, and to detect and communicate facial expressions, facial movements, eye movements and/or mouth movements to a computing device—such as an external game console or a processor integrated into the headset—that provides extended expressive functionality to the headset and associated computing device based on the detected facial expression of the user. In particular, when the VR headset 150 with installed sensor assembly 170 is worn by a user, the sensor assembly 170 is configured to: sit between the view window of the VR headset 150—around a display integrated into the VR headset 150—and the user's face; to cushion the view window around the user's face; and conform to the user's facial structure while depressing the sense electrodes 123 and reference electrodes 124 against the user's skin. For example, the sensor assembly 170 can define a perimeter configured to extend across and to contact: the left and right supraorbital regions; the zygomatic regions; the infraorbital regions; and the lower frontal region and/or the upper nasal region of a user's face when the headset is worn by the user. The sensor assembly 170 can thus include electrodes 122 supported directly against a user's skin—rather than against the user's facial hair—at convex regions of the user's face, which may enable sufficient electrode-to-skin contact and reduce noise in signals read from these electrodes 122 due to poor skin-electrode contact.

In one implementation, the system 100 defines an aftermarket headset augmentation system in which: the passive sensor assembly 170 is configured to replace a gasket arranged around the perimeter of the view window of the VR headset 150, such as with a hook-and-loop attachment system. In this implementation, the controller 140 and signal processing circuitry can be arranged in a housing configured to install remotely from the sensor assembly 170, such as: to mount to the body of the headset with a hook-and-loop attachment system; or to connect to a head strap on the headset with a clip or loop extending from the housing and configured to receive or clip onto the head strap. In this example, the signal processing circuitry can condition signals read from electrodes 122 in the sensor assembly 170, and the controller 140 can locally transform these signals into facial expressions, facial movements, and/or mouth movements of a user; and the system 100 can further include a wireless communication module configured to broadcast facial state updates or commands related to these detected facial expressions, facial movements, and/or mouth movements to the headset or to a computing device nearby (e.g., a gaming console) for embodiment in a virtual avatar within a virtual environment.

In another implementation, the system 100 defines an integrated headset product in which the headset is supplied with the sensor assembly 170 arranged around the view window and in which the controller 140 and signal processing circuitry are integrated into the headset.

Alternatively, in the foregoing implementations, conditioned signals—read from the electrodes 122 in the sensor assembly 170 and processed by the signal processing circuitry—can be transmitted (e.g., wirelessly or via a wired connection) to an external computing device nearby for transformation into facial expressions and/or facial movements of the user.

In the foregoing implementations, the sensor assembly 170 can be permanently installed around the view window of the headset, such as with adhesive. Alternatively, the sensor assembly 170 can be disposable and configured to transiently install around the view window of the headset. For example: one component of a hook-and-loop attachment system can be adhered across all or a portion of the exterior surface of the sensor assembly 170—opposite the electrodes 122; and a complementary component of a hook-and-loop attachment system can be attached to the headset at corresponding locations around the view window. In this example, one unit of the sensor assembly 170 can be installed on the headset by mating the components of the hook-and-loop attachment system; after some period of use, once surfaces of the electrodes 122 exhibit sufficient wear, once signal quality from the first unit of the sensor assembly 170 has dropped below a threshold, or once a channel of the first unit of the sensor assembly 170 has ceased to function, the first unit of the sensor assembly 170 can be replaced with a second unit of the sensor assembly 170. In other examples, the sensor assembly 170 can be transiently (e.g., removably) connected to the headset with magnets, with mechanical fasteners, with snaps, or by installing the sensor assembly 170 into an undercut channel around the perimeter of the view window of the VR headset 150, etc. Thus, the elastic member 110 can transiently couple to the headset via a hook-and-loop attachment surface arranged over the substrate 130, the hook-and-loop attachment surface configured to align with a corresponding hook-and-loop attachment surface on the headset.

However, a unit of the sensor assembly 170 can be integrated into or installed on a VR headset 150 or headset of any other type with a similar geometry (e.g. ski goggles, mountain bike goggles, face shields for manufacturing applications, etc.) and in any other suitable way.

### 3.1 Optical Glasses Variation and Integration

As shown in FIG. 6, the system 100 can be configured to integrate with a headset that can be a pair of optical glasses or goggles outfitted with a processor for controlling the opacity of the lenses, for displaying augmented reality images to the user, or for displaying a heads-up-display (HUD) to the user. In particular, when the goggles (e.g. ski goggles, mountain biking goggles, welding goggles, etc.) with installed sensor assembly 170 are worn by a user, the sensor assembly 170 can be configured in a similar configuration to the VR headset variation, and can detect and communicate the facial expressions, facial movements, eye movements and/or mouth movements to a computing device or processor integrated with the goggles. The integrated processor can then increase the opacity of the lenses of the goggles in response to detecting the user squinting or perform any other function responsive to detected facial expressions or movements of the user.

In an alternative variation, the system can be integrated with a pair of optical glasses, and the electrodes 122 can be located between the nose pads of the optical glasses and the user's nose bridge region and between at least two points on the frame of the glasses in contact with the left and right supraorbital regions or left and right zygomatic regions of the user's face. Because optical glasses are typically held on a user's head primarily via the force of gravity and secondarily by the elasticity of the temples behind the user's ear, the electrodes 122 can be located in different positions than in the VR headset 150 variation. For example, the sensor assembly 170 can define discrete sense electrodes 123 in four or more separate locations on the pair of optical glasses: an upper left sense electrode coupled to the frame as it sweeps back toward the temple and configured to proximally contact a left upper orbicularis oculi muscular region of the face of the user; an upper right sense electrode coupled to the frame as it sweeps back toward the temple and configured to proximally contact a right upper orbicularis oculi muscular region of the face of the user; a left nose pad sense electrode coupled to the internal surface of the nose pads of the headset and configured to proximally contact a left levator labii superioris alaeque nasi muscular region (i.e. to the immediate left side of the nose bridge region) of the face of the user when the headset is worn by the user; and a right nose pad sense electrode coupled to the internal surface of the nose pads of the headset and configured to proximally contact a right levator labii superioris alaeque nasi muscular region (i.e. the immediate right side of the nose bridge region) of the face of the user when the headset is worn by the user. However, depending on the design of the frame of the optical glasses, the electrodes 122 and corresponding elastic members 110 can be located elsewhere on the frame, where it comes into close proximity to the user's skin (e.g. the left or right infraorbital or zygomatic regions of the face; or the left or right temples of the user).

In this variation, as shown in FIG. 6, the substrate 130, electrical traces 128, electrical pads 134, electrical channels 132, common junction 136, and controller 140 are located internally within the frame of the optical glasses. Electrical pads 134 on the internal substrate can be exposed by openings in the frame to allow for electrical contact between the electrodes 122 and the electrical pads 134 on the substrate 130.

In one implementation, the discrete elastic members 110 and corresponding electrodes 122 are individually replaceable using a snap or other mechanical fastening method—wherein a user can remove and replace each electrode 122 and/or discrete elastic member 110 from its location on the frame or nose pad of the optical glasses—while the substrate 130, electrical traces 128, electrical pads 134, electrical channels 132, and common junction 136 are permanently integrated within the frame of the glasses.

In one implementation, a gasket like elastic member 110 can be positioned across the top of the optical glasses frame in the supraorbital region of the user's face when the user is wearing the optical glasses, and can include multiple electrodes 122. A second elastic member 110 or members can be positioned on the nose pads in the nose bridge region of the user's face when the user is wearing the optical glasses.

In one implementation, the electrodes 122 are manufactured from a durable conductive material, such as solid copper, silver chloride coated solid silver, or any other conductive metallic or non-metallic substance. The durable conductive electrodes 122 can be integrated directly into the frame and can be permanent fixtures on the glasses.

In one implementation, the system 100 includes a controller 140 integrated into the optical glasses or goggles, which can read and process electrical signals from the sensor assembly 170. In response to the controller 140 indicating that the user is squinting, the controller 140 or another processor integrated into the optical glasses or goggles can increase the opacity of electrochromic lens or lenses of the optical glasses or goggles via an applied voltage on the lenses.

However, the sensor assembly 170 can be integrated with a pair of optical glasses or goggles in any other way.

### 4. Elastic Member

The elastic member 110: is configured to couple to a headset or pair of optical glasses or goggles; is configured to extend along supraorbital regions, zygomatic regions, and infraorbital regions of a face of a user when the headset is worn by the user; defines an opening configured to align with palpebral regions of the face of the user when the headset is worn by the user; and includes a compressible material configured to conform to the face of the user when the headset is worn by the user. The elastic member 110 can be continuous and can extend along supraorbital regions and zygomatic regions of the face of the user and is offset from ocular regions of the face of the user when the headset is worn by the user, thereby allowing the user to see.

Generally, the elastic member 110 functions as a soft, compressible gasket that buffers the geometry of the headset, optical glasses, or goggles, around a view window or set of lenses to a user's unique facial structure and that depresses flexible electrodes 122 against skin on the user's face, thereby deforming the electrodes 122 into conformation with the user's facial structure to achieve sufficient contact between the electrodes 122 and the user's skin to reduce noise in EMG signals read from these electrodes 122 due to poor electrode contact.

In one implementation shown in FIGS. 2, 3A, 3B, and 4, the elastic member 110 can define a closed-loop configured to: extend from the lower frontal region of the face above the nasal bridge, across the left supraorbital region, around the left zygomatic region to the left infraorbital region, over the nose below the nasal bridge, across the right infraorbital region to the right zygomatic region, up the supraorbital region, and back to the lower frontal region of the face above the nasal bridge to close the loop. Alternatively, the elastic member 110 can define an open loop, such as open over the nose of a user's face below the nasal bridge. Yet alternatively, the elastic member 110 can include two separate, discrete components, including: a left component configured to contact the left side of a user's face around the user's left eye; and a right component configured to contact the right side of a user's face around the user's right eye.

The elastic member 110 can be constructed of foam, such as polyurethane or neoprene foam. For example, the elastic member 110 can be cast in a mold or cut from planar foam sheet, such as with a punch and die. In this implementation, the elastic member 110 can be of closed-cell foam (e.g., neoprene) in order to reduce breathability of the elastic member 110 and thus increase local sweating on the user's face when the headset is worn by the user, which may in turn improve electrical conductivity between electrodes 122 and the user's skin and thus improve signal-to-noise ratio (or “SNR”) of the signals detected by these electrodes 122.

In the variation shown in FIG. 6, in which the system 100 is integrated with a pair of optical glasses, the elastic member 110 can be discontinuous and can be positioned in different locations than in other variations. For example, the elastic member 110 can be located on the nasal pads of the optical glasses at the nasal bridge region of a user's face when wearing the optical glasses and/or on the frame of the optical glasses proximal to the left and right zygomatic regions of a user's face when wearing the optical glasses. Additionally, the elastic member no can be constructed out of a different elastic material, for example, a rubber or silicon compound. Alternatively, in this variation, the electrodes 122 can be directly affixed to the nose pads and/or frame of the optical glasses with no interposed elastic member no. In one implementation, one elastic member no extends across from the left to the right supraorbital regions of the face of the user when the user is wearing the optical glasses, while another elastic member 110 is located in the nasal bridge region of the face of the user.

However, the elastic member no can be of any other form and constructed in any other soft, compressible, flexible, and/or elastic material.

### 5. Sense and Reference Electrode Layout

The sense electrodes 123 and reference electrodes 124 define passive, monopolar conductors configured to contact a user's skin directly and to communicate voltage potentials on a user's skin back to the controller 140 (e.g., via the substrate 130 and a connector, as described below). Generally, the sense electrodes 123 can be arranged over regions of the elastic member no that: commonly oppose distinct muscle groups in the human face responsible for facial and mouth motions; and/or that commonly oppose convex regions of the human face (e.g., over the zygomatic or “cheek” bones, supraorbital bones of the human skull). In particular, the sense electrodes 123 can be arranged in particular locations on the elastic member no in order to achieve both: detection of a limited number of EMG signals representative of a variety of facial expressions or facial expression changes; and effective contact with a user's skin. However, because the signal processing circuitry reads a difference between a signal received from a sense electrode and a signal received from the reference electrode, the reference electrode 124 can be arranged on a region of the elastic member 110 that commonly faces smaller or less active facial musculature (i.e. low-muscle regions), such as over the nasal bridge, in order to limit rejections of significant signal components from EMG signals received from the sense electrodes.

In one implementation, the system 100 includes a reference electrode 124 that is coupled to the elastic member 110 and configured to contact a low-muscle region on the face of the user when the headset is worn by the user; including a reference electrode 124 defining an electrical contact surface facing outwardly from an interior face of the elastic member no opposite the substrate 130 and configured to contact skin on the face of the user when the headset is worn by the user; and electrically coupled to an electrical channel 132, in the set of electrical channels 132, defined on the substrate 130.

In one implementation shown in FIG. 4, the system 100 includes four sense electrodes 123, including: a lower left sense electrode 123A arranged at a left zygomaticus/left levator labii superioris muscle region of the elastic member no (i.e., under the left eye); an upper left sense electrode 123B arranged at a left upper orbicularis oculi muscle region of the elastic member no (i.e., over the left eye); a lower right sense electrode 123C arranged at a right zygomaticus/right levator labii superioris muscle region of the elastic member no (i.e., under the right eye); and an upper right sense electrode 123D arranged at a right upper orbicularis oculi muscle region of the elastic member no (i.e., over the right eye). In this implementation, the system 100 can also include a single reference electrode 124 arranged over a procerus muscle at the nasal bridge region of the elastic member 110.

In another implementation shown in FIG. 2, the system 100 further includes: an outer left sense electrode 123E arranged at a left outermost orbicularis oculi muscle region of the elastic member 110 (i.e., to the left of the left eye); and an outer right sense electrode 123F arranged at a right outermost orbicularis oculi muscle region of the elastic member 110 (i.e., to the right of the right eye). Furthermore, the system 100 can also include: an upper-inner left sense electrode arranged over a left upper orbicularis oculi/procerus muscle junction region of the elastic member 110 (i.e., over the left eye between the upper left sense electrode and the vertical centerline of the elastic member 110); and an upper-inner right sense electrode arranged over a right upper orbicularis oculi/procerus muscle junction region of the elastic member 110 (i.e., over the right eye between the upper right sense electrode and the vertical centerline of the elastic member no).

In the variation shown in FIG. 6 in which the system 100 is integrated into or coupled to a pair of optical glasses, the system 100 includes four sense electrodes including: an upper left sense electrode 123G coupled to the frame and configured to proximally contact a left upper orbicularis oculi muscular region of the face of the user when the headset is worn by the user; an upper right sense electrode 123H coupled to the frame and configured to proximally contact a right upper orbicularis oculi muscular region of the face of the user when the headset is worn by the user; a left nose pad sense electrode 123I coupled to the internal surface of the nose pads of the headset and configured to proximally contact a left levator labii superioris alaeque nasi muscular region of the face of the user when the headset is worn by the user; and a right nose pad sense electrode 123J coupled to the internal surface of the nose pads of the headset and configured to proximally contact a right levator labii superioris alaeque nasi muscular region of the face of the user when the headset is worn by the user. However, the sense electrodes can be arranged anywhere on the frame and/or nose pads of the optical glasses.

However, the system 100 can include any other number of sense electrodes 123 and/or reference electrodes 124 arranged in any other configuration over the elastic member 110. Furthermore, the system 100 can exclude a physical reference electrode 124, and the controller 140 can instead calculate a virtual reference signal as a function of a linear combination of sense signals read from sense electrodes 123 on the sensor assembly 170.

### 6. Substrate and Electrodes

The substrate 130 is arranged across an exterior surface of the elastic member 110 (i.e., opposite a user's face) and defines a set of discrete electrical channels 132. The set of electrode tabs 120 are distributed along the elastic member 110 and define a set of electrodes 122, wherein each electrode 122 is arranged on the interior surface of the elastic member 110, faces opposite the substrate 130 (i.e., toward a user's skin), and is electrically coupled to one electrical channel 132 on the substrate 130.

### 6.1 Unitary Substrate and Electrode Tabs

In one implementation shown in FIG. 4 and a manufacturing method shown in FIG. 7, the substrate 130 and electrode tabs 120 form a unitary structure. In this implementation, conductive metallic ink (e.g., silver ink with a silver chloride coating over exposed regions) is screen-printed or otherwise applied to an exterior surface of a sheet of flexible substrate material, such as polyimide, polyether ether ketone (or “PEEK”), transparent conductive polyester film, or thermoplastic polyurethane (or “TPU”) to form a set of discrete (round) electrodes 122, one discrete electrical channel 132 per electrode and terminating on one end at a common junction 136, and one discrete trace extending from a corresponding electrode 122 to a corresponding electrical channel 132, as shown in Block Silo. In particular, the common junction 136 can be defined near a planned edge of the substrate 130, the discrete electrical channels 132 can extend along a planned substrate 130 area matching the geometry of the elastic member 110, and the traces can extend over planned electrode tab areas to electrodes offset inside or outside of the planned substrate 130 area on the sheet of flexible substrate material, as shown in FIG. 4.

The exterior surface of the sheet of flexible substrate material and the conductive material—exclusive of the electrodes 122 and the common junction 136—can then be covered or coated as shown in Block S120. For example, once the conductive material is applied to the exterior surface of the sheet of substrate material and cured: a second layer of nonconductive material, such as TPU, can be perforated at regions corresponding to the electrodes 122 and the common junction 136 on the exterior surface of the sheet of substrate material; and the second layer of nonconductive material can be aligned with and bonded to the exterior surface of the sheet of substrate material.

Alternatively, the exterior surface of the sheet of substrate material can be mechanically masked across the electrodes 122 and common junction 136; and a nonconductive coating (e.g., a polyurethane, an epoxy, a thermoplastic, or latex, etc.) can be sprayed across the exposed area of the sheet of substrate material to enclose the electrical channels 132, thereby preventing shorting across channels and protecting these channels against environmental contaminants. In one implementation, the nonconductive coating can be printed directly onto the flexible substrate material such that it encloses the electrical traces 128 and electrical channels 132 without the use of mechanical masking. Additionally, non-oxidative coatings such as a silver chloride coating can be applied to the electrodes 122 before or after the nonconductive coating has been applied. Thus, the step of applying various inks to the flexible substrate 130 can include: applying a layer of silver ink to thermoplastic polyurethane; applying a layer of silver chloride over the set of sense electrodes 123; and applying a layer of thermoplastic polyurethane over the set of electrical traces 128, electrical channels 132, and the common junction 136.

In one implementation, the substrate 130 and the electrode tabs 120 form a unitary structure defining: a substrate ring defining the set of discrete electrical channels 132 and a common junction 136 and conforming to the geometry of the elastic member 110; for each electrode tab 120 in the set of electrode tabs 120: an electrode tab area defining the electrode tab 120 and extending radially from a perimeter of the substrate ring; and a cover layer covering the set of discrete electrical channels 132, the enclosed traces in the set of electrode tabs 120, and the common junction 136.

The sheet of substrate material and the layer of nonconductive material—enclosing the electrical channels 132, electrical traces 128, and electrodes 122—can then be trimmed or selectively cut, such as with a computer-controlled plotting tool or laser cutter, to form a substrate-electrode assembly 160 including a substrate ring and a set of electrode tabs 120 extending from the substrate ring, wherein each electrode tab 120 terminates at or around an exposed electrode 122 (i.e., an electrode 122 not covered by the layer of nonconductive material), as shown in Block S130. For example, each electrode tab 120 can extend outwardly from the perimeter of the substrate ring and can be folded around the exterior of the elastic member 110 to limit a user's visibility of electrode tabs 120 when the user wears the headset. Alternatively, the electrode tabs 120 can extend inwardly toward the center of the substrate ring, such as to reduce material waste.

The process can be implemented continuously along a sheet roll of substrate material and an adjacent sheet roll of the nonconductive material, such as by: sequentially stamping or printing conductive material onto the exterior surface of a sheet of substrate material to form one discrete group of electrodes 122, traces, and electrical channels 132 per unit of the substrate-electrode assembly 160; curing the conductive material; perforating a sheet of the nonconductive material at the locations of electrodes 122 on the adjacent sheet of substrate material, such as with a first die cutter; aligning and merging the sheet of substrate material and the sheet of nonconductive material; and bonding the sheet of substrate material and the sheet of nonconductive material together, such as between a pair of heated rollers. In this example, as regions of the sheet of substrate material and the sheet of nonconductive material are bonded together and passed through the pair of rollers, this stack can be passed continuously through a second die cutter, which can separate units of the substrate-electrode assembly 160 from the stack, each in the form of a substrate ring and a set of electrode tabs 120 extending radially from the ring and wherein each electrode tab 120 terminates at or around an exposed electrode 122 (i.e., an electrode 122 not covered by the nonconductive material).

Once the unitary substrate-electrode assembly 160, including the substrate ring with radially extending substrate tabs, has been cut from the flexible substrate sheet, the component can be adhered to the elastic member 110, as shown in Block S140, to assemble the sensor assembly 170. The substrate ring—including the electrical traces 128, electrical channels 132, and common junction 136—is configured to align with the shape of the elastic member 110. As such, an adhesive can be applied to the interior surface of the substrate ring such that it adheres with the exterior surface of the elastic member 110, wherein the interior surface of the substrate ring is the surface opposite the electrical traces 128 and common junction 136. Adhesive can then be applied to the interior surface of the extending sense electrode tabs 120, which can then be folded or wrapped around the elastic member 110 such that the electrodes 122 at the end of the electrode tabs 120 face internally (i.e. toward the user's face) opposite their original orientation. Thus, the electrodes 122 are adhered to the interior surface of the elastic member no and contact the face of the user when a headset including the elastic member 110 is worn by the user. However, the substrate-electrode assembly 160 can be adhered, bonded, or otherwise coupled to the elastic member 110 in any other way.

Once the sensor assembly 170 including the elastic member no and substrate-electrode assembly 160 is assembled, an adherent can be applied to an exterior surface of the sensor assembly 170, wherein the adherent is configured to transiently couple the sensor assembly 170 to a view window of a VR headset 150, or around the lenses of a pair of optical goggles, as shown in Block S150. For example, the adherent can be a hook-and-loop attachment surface corresponding to a hook-and-loop attachment surface around the view window of the VR headset 150. Alternatively, the adherent can be a temporary adhesive that can be effectively removed from the VR headset 150 by peeling the sensor assembly 170 from the headset. Additionally, the common junction 136 can be electrically coupled to the VR headset 150.

### 6.2 Discrete Substrate and Electrode Tab Structures

In another implementation shown in FIG. 1 and a manufacturing method shown in FIG. 8, electrical channels 132—each terminating on one end at a common junction 136 and on an opposite end at an electrical pad 134—are fabricated over the interior surface of flexible PCB substrate 130 (e.g., a polyimide, PEEK, or polyester sheet or film), such as by etching a copper foil on the flexible PCB to form these electrical channels 132 and other features as shown in Block S210. Alternatively, conductive ink can be printed onto the surface of the flexible substrate 130. The flexible PCB substrate 130 is then masked (e.g., mechanically) over the common junction 136 and over the electrical pads 134; and exposed areas of substrate 130 are sealed, such as with a spray or dip coating or by adhering a sheet of nonconductive material (e.g., TPU) over these areas of the substrate 130. The substrate 130 is then trimmed to form a ring of geometry substantially similar to that of the exterior surface of the elastic member no, as shown in Block S220.

In this implementation, electrode tabs 120 are fabricated separately. For example, an electrode 122, a junction pad 126, and an electrical trace 128—extending between the electrode 122 and the junction pad 126—can be screen-printed onto the exterior surface of a first flexible, nonconductive layer or base layer (e.g., a sheet of TPU), as shown in Block S230. A second flexible, nonconductive layer is bonded over the first flexible layer across the trace, thereby insulating the trace and completing the electronic tab, as shown in Block S232. In this example, methods and techniques similar to those described above can be implemented to: produce electrode tabs 120 in bulk on sheet rolls of flexible, nonconductive material; screen-print or stamp conductive material onto the exterior surface of the first sheet of flexible, nonconductive material to form discrete electrode 122, junction pad 126, and trace groups; perforate or selectively cut the second sheet of the flexible, nonconductive material at locations of electrodes 122 and junction pads 126 on the first sheet of flexible, nonconductive material, as shown in Block S240; bond the first and second sheets of flexible, nonconductive material together, such as by passing these two sheets—in alignment—through a pair of heated rollers; and then separate each electrode tab 120, such as with a punch and die.

Thus, an electrode 122 can include: a base layer including a nonconductive polymer; conductive ink deposited across a first surface of the base layer; a junction pad 126 comprising conductive ink deposited across the first surface of the base layer; and an enclosed trace. The enclosed trace including an electrical trace 128 including conductive ink deposited between the junction pad 126 and the electrode 122 across the first surface of the base layer; and a nonconductive cover layer bonded to the base layer and enclosing the electrical trace 128 between the nonconductive cover layer and the base layer. Furthermore, an electrode tab 120 can include: a base layer fabricated from thermoplastic polyurethane; conductive ink including silver ink with a silver chloride coating that prevents oxidation of the silver ink.

Electrode tabs 120 can then be connected to the substrate 130 to complete the substrate-electrode assembly 160, as shown in Block S250. In particular, a junction pad 126 of an electrode tab 120—exposed across the exterior surface of the electrode tab 120—can be arranged over an exposed electrical pad 134 on the interior surface of the substrate 130 and can be fixed to the substrate 130, such as with the electrode tab 120 extending outwardly from the perimeter of the substrate 130 or facing toward the center of the substrate ring, as described above. For example, the junction pad 126 of the electrode tab 120 can be bonded to its corresponding electrical pad 134 on the substrate 130 with a conductive adhesive. In another example, the electrode tab 120 and the substrate 130 can be mechanically fastened with a (conductive) rivet passing through the junction pad 126 and the electrical pad 134. In yet another example, the first and/or second layers of the electrode tab 120 can extend around the perimeter of the junction pad 126 and can be of TPU; the electrode tab 120 can thus be bonded to the substrate 130 by compressing and heating the electrode tab 120 around the junction pad 126 against the substrate 130, such as after conductive paste is applied between the junction pad 126 and the electrical pad 134.

Once the substrate-electrode assembly 160, including the substrate ring and attached radially extending substrate tabs, has been assembled, the substrate-electrode assembly 160 can be adhered to the elastic member 110, as shown in Block S260, to create the sensor assembly 170. The substrate ring including the electrical channels 132 and common junction 136 is configured to align with the shape of the elastic member 110. As such, an adhesive can be applied to the interior surface of the substrate ring such that it adheres with the exterior surface of the elastic member 110, wherein the interior surface of the substrate ring is the surface including the electrical traces 128 and common junction 136. Adhesive can then be applied to the interior surface of the extending sense electrode tabs 120, which can then be folded or wrapped around the elastic member 110 such that the electrodes 122 at the end of the electrode tabs 120 face internally, opposite their original orientation (i.e. toward the user's face). Thus, the electrodes 122 are adhered to the interior surface of the elastic member 110 and contact the face of the user when a headset including the sensor assembly is worn by the user. However, the substrate-electrode assembly 160 can be adhered, bonded, or otherwise coupled to the elastic member 110 in any other way.

Therefore, in one implementation, when the planar electrode-substrate assembly 160 is attached to the elastic member 110: the base layer of the electrode tab 120 can be bonded to an interior surface of the substrate 130, wherein the base layer is interposed between the substrate 130 and the elastic member 110, and the junction pad 126 contacting a discrete electrical channel 132 in the set of electrical channels 132 on the substrate 130; the base layer further defines a second surface, opposite the first surface of the base layer, wherein the second surface contacts an outer perimeter surface of the elastic member 110 and is coupled to the interior surface of the elastic member 110; and the electrode 122 of each electrode tab 120 faces outwardly from the first surface of the base layer and is configured to contact skin on the face of the user when the headset is worn by the user.

Once the sensor assembly 170 including the elastic member 110 and substrate-electrode assembly 160 is assembled, an adherent can be applied to an exterior surface of the sensor assembly 170, wherein the adherent is configured to transiently couple the sensor assembly 170 to a view window of a VR headset 150, or pair of optical goggles, in Block S270. For example, the adherent can be a hook-and-loop attachment surface corresponding to a hook-and-loop attachment surface around the view window of the VR headset 150, or pair of optical goggles. Alternatively, the adherent can be a temporary adhesive that can be effectively removed from the VR headset 150, or pair of optical goggles, by peeling the sensor assembly 170 from the headset. Additionally, the common junction 136 can be electrically coupled to the VR headset 150, or pair of optical goggles.

However, a planar substrate-electrode assembly 160—including a substrate ring with electrode tabs 120 extending outwardly or inwardly from the substrate ring—can be fabricated in any other way and in any other material.

### 6.3 Internally Integrated Substrate and Electrode Pads

In one variation, shown in FIG. 6, in which the system is integrated into a pair of optical glasses 180, the substrate 130 can be internally integrated directly into the frame of the optical glasses 180. In one implementation, the internally integrated substrate 130 is a thin flexible PCB interposed between material layers of the frame of the optical glasses 180 and connecting directly with the controller 140 integrated with the frame of the optical glasses 180. Alternatively, electrical channels 132 or wiring can be imbedded directly into the frame material itself, connecting the electrodes 122 to the controller 140 integrated with the optical glasses. The electrical channels 132 or wiring can extend over or around the hinges of the optical glasses to a controller 140 integrated with the temples of the optical glasses.

In one implementation, electrode tabs 120 can be adhered to the internal substrate and extend out of the frame of the optical glasses 180 through slits in the frame of the optical glasses 180. In this implementation, depending on the orientation of the electrode tabs 120 exiting the frame of the optical glasses 180, the electrode tabs 120 can be adhered to elastic members no on the interior surface of the optical glasses 180.

In one implementation, the electrodes 122 can be affixed directly to the frame of the optical glasses 180, thereby coming into direct contact with electrical channels 132 integrated in the frame of the optical glasses. In this implementation, the internal substrate can include spring contacts arranged at the attachment points for the electrodes 122 such that, when the electrodes 122 are attached to the frame, the electrodes 122 are electrically coupled to the electrical channels 132.

However, the electrical contact between electrodes 122 affixed to a pair of optical glasses and a controller 140 integrated with the pair of optical glasses can be established in any other way.

### 7. Common Junction

As shown in FIGS. 1 and 2, a common junction 138 can then be connected to the common junction 136 on the substrate 130. For example, a wire can be bonded or soldered directly over its corresponding electrical channel 132 at the common junction 136 on the substrate 130; opposing ends of these wires can terminate in a plug configured to transiently engage a receptacle coupled to the signal processing circuitry, and these wires can be bundled and wrapped to form a wiring harness 138. Alternatively, a wiring harness 138 receptacle can be bonded, soldered, or mechanically fastened to the substrate 130 over the common junction 136; and a wiring harness 138 can then be installed in the wiring harness receptacle.

In yet another example, the substrate 130 includes a tongue extending outwardly from the substrate ring and terminating at its far end in the common junction 136; the discrete electrical channels 132 run along the tongue and terminate at the common junction 136 and are covered or coated with a nonconductive material, as described above. In this example, the end of the tongue can function as a plug and can be configured to directly engage a receptacle coupled to the signal processing circuitry.

However, the system 100 can include a wiring harness 138 of any other form attached to the common junction 136 on the substrate 130 in any other way or any other feature or component configured to communicate voltage potentials at the sense electrodes 123 and reference electrodes 124 to the signal processing circuitry.

### 8. Assembly

The elastic member 110 and the substrate-electrode assembly 160 can be bonded together or otherwise assembled, as shown in FIGS. 7 and 8. In particular, the exterior surface of the elastic member 110 is bonded to the interior surface of the substrate 130; and electrode tabs 120 extending from the substrate ring defined by the substrate-electrode assembly 160 are wrapped around the elastic member 110 and bonded to the interior surface of the elastic member 110 with the exposed surfaces of the electrodes 122 facing opposite the elastic member 110 to form the passive sensor assembly 170. Thus, when a user wears a headset outfitted with the sensor assembly 170: the exposed surfaces of the electrodes 122 can contact select regions of the user's face; the elastic member 110 can depress the electrodes 122 against the user's skin around the view window or lens of the headset; and the electrodes 122 can locally deform with the elastic member 110 against the user's face to achieve both persistent contact between the electrodes 122 and the user's skin and sufficient comfort for the user.

In one example, an adhesive (e.g., contact cement) is applied to the exterior surface of the elastic member 110 and/or to the interior surface of the substrate iso; the exterior surface of the elastic member 110 is then aligned with and bonded to the interior surface of the substrate 130. In this example, adhesive can also be applied to select regions of the interior surface of the elastic member 110 adjacent each electrode tab 120; and each electrode tab 120 can then be wrapped around the elastic member 110 and bonded to the interior surface 112 of the elastic member 110.

A component of a hook-and-loop attachment system can then be adhered across all or a portion of the exterior surface of the substrate 130 to complete the sensor assembly 170; this hook-and-loop component on the sensor assembly 170 can then transiently engage a complementary hook-and-loop component arranged on a headset to transiently retain the sensor assembly 170 around the view window of the headset, as described above. Alternatively, a button snap or other attachment component can be bonded or otherwise coupled to the sensor assembly 170 and configured to transiently retain the sensor assembly 170 around the view window of a headset.

However, the elastic member 110 and the substrate-electrode assembly 160 can be assembled in any other way.

### 9. Perforated Electrodes

In one variation, an electrode tab 120 is perforated through its electrode 122. In this variation, perforations in the electrode 122 can enable the electrode tab 120 to deform and to conform against a user's skin, thereby improving electrical contact therebetween. These perforations can also retain moisture (e.g., sweat) around the electrode 122 and adjacent the user's skin, thereby improving electrical conductivity between the electrode 122 and the user's skin. Furthermore, these perforations may grip a user's skin, thereby reducing motion of the electrode 122 across the user's skin, which may induce noise in the channel.

Additionally or alternatively, the electrode tab 120 can be slit around or through the electrode 122 to improve conformation of the electrode 122 against the user's skin. However, an electrode tab 120 can define any other geometry through or adjacent its electrode 122.

### 10. Formed Electrodes

As described above, a thin flexible planar electrode 122 can be fabricated on a thin flexible planar sheet or film (e.g., TPU); this electrode tab 120 can then be wrapped around the elastic member 110 such that an exposed area of the electrode 122 faces a user's skin when a headset—outfitted with the sensor assembly 170—is worn by the user.

In another variation, an electrode tab 120 can be formed into a three-dimensional structure. For example, once fabricated, an electrode tab 120 can be heat-formed over a domed (i.e., three-dimensional) mandrel in order to dome the electrode tab 120 across the electrode 122. The electrode tab 120 can then be installed over the elastic member 110 with the convex electrode 122 facing out from the interior surface of the elastic member 110.

However, an electrode tab 120 and its electrode 122 can be of any other two- or three-dimensional form.

### 11. Electrode Fabrication on Elastic Member

In one variation, electrodes 122 are fabricated directly onto the elastic member 110, such as by screen-printing or spraying conductive material directly onto discrete regions of the elastic member 110 to form electrodes 122.

In one implementation, the elastic member 110 is cast in foam (e.g., open-celled foam to enable conductive ink to penetrate into and to be absorbed by the foam) and is perforated at the location of each electrode 122 to form a set of vias. Conductive material (e.g., silver ink) can then be screen-printed onto the interior surface of the elastic member 110 around and into each via to form the set of discrete electrodes 122; in particular, conductive material can extend continuously from a discrete region on the interior surface of the elastic member 110, through the via, to the exterior surface of the elastic member 110. In this implementation, the substrate 130 can include: a flexible PCB defining a geometry similar to the cross-section of the elastic member 110; one electrical pad 134 arranged on the interior surface of the flexible PCB at the location of each via in the elastic member 110; and one discrete electrical trace 128 arranged on the interior surface of the flexible PCB and extending from each electrical pad 134 to a common junction 136 near an edge of the flexible PCB. The substrate 130 can then be aligned with a foam ring, and the interior surface of the substrate 130 can be bonded to the exterior surface of the foam ring; each electrical pad 134 on the interior surface of the substrate 130 can thus contact conductive material that coats an adjacent via in the foam ring, thereby electrically connecting the corresponding electrode 122 on the interior surface of the elastic member 110 to its corresponding electrical channel 132 on the substrate 130.

For example: adhesive can be applied to the interior surface of substrate 130 outside of the electrical pads 134 and the common junction 136; conductive paste can be applied to (e.g., screen-printed onto) the electrical pads 134; and the substrate 130 can be aligned with and adhered to the elastic member 110 to complete the sensor assembly 170. Additionally or alternatively: adhesive can be applied across the exterior surface of the elastic member 110; conductive paste can be applied to the exterior surface of the elastic member 110 around the vias; and the interior surface of the substrate 130 can be bonded to the exterior surface of the elastic member 110 to enclose open electrical channels 132 extending across the interior surface of the substrate 130.

In another example, the substrate 130 can include TPU, the electrical channels 132 and electrical pads 134 can be screen-printed onto the substrate 130, and the substrate 130 can be compressed against the exterior surface of the elastic member 110 and heated to bond the substrate 130 to the elastic member 110 with the substrate 130 and the elastic member 110 enclosing the electrical channels 132 and electrical pads 134.

However, electrodes 122 can be fabricated directly onto the interior surface of the elastic member 110 in any other suitable way. Electrical channels 132 and the common junction 136 can be similarly fabricated across the exterior surface of the elastic member 110.

### 12. Conductive Inks and Coatings

In the implementations and variations described above, electrodes 122, electrical traces 128, junction pads 126, electrical channels 132, electrical pads 134, etc. can include silver ink printed directly onto the electrode tab 120 and directly onto the substrate 130 (or directly onto the elastic member 110). Exposed areas of silver ink not covered in a second layer of nonconductive material can be further coated with silver chloride ink, such as by screen-printing. In particular, silver ink may exhibit relatively low volume electrical resistivity but may oxidize relatively quickly and may exhibit relatively high surface resistivity when oxidized; silver chloride ink may exhibit volume electrical resistivity greater than that of silver ink but may oxidize slowly relative to silver ink and may therefore exhibit low surface resistivity more consistently over time than exposed silver ink. Therefore, in the foregoing implementations and variations, exposed silver ink can be coated with silver chloride ink in order to maintain relatively low bulk volume electrical resistivity and relatively low (and consistent) surface resistivity at each electrode 122 over time. In one implementation, non-metallic conductive inks such as conductive carbon nanotube ink or graphene ink can be printed onto the electrode tab 120 or the substrate 130. Carbon nanotube or graphene ink may exhibit relatively low bulk volume electrical resistivity and surface resistivity while also being immune to oxidation. Because conductive non-metallic inks do not oxidize, a non-oxidative conductive coating such as silver chloride is not applied, thereby removing a step from the manufacturing process of the electrode tabs 120.

### 13. Controller, Signal Processing, and Facial Detection

The controller 140 is configured: to read a set of sense signals read from the sense electrodes 123 defined by the set of sense electrode tabs 120; to interpret changes in the set of sense signals over time as expressions change on the face of the user when the headset is worn by the user; and to output the expressions to: a game console for representation on a virtual avatar in a virtual environment rendered on the headset; to a computational device to represent the user's emotion in connection with a concurrent message or other media; to an on-board processor on the headset to control the brightness or location of a screen or augmented reality projection of the headset; or to an on-board processor to control the opacity of a lens in a pair of optical glasses or goggles. In particular, the controller 140—in conjunction with signal processing circuitry—functions to read voltage potentials from sense electrodes 123 on the sensor assembly 170 (e.g., a relative to a reference potential read from the reference electrode 124) and to interpret these voltage potentials as facial expressions, transitions between facial expressions, facial movements, and/or mouth movements, etc. Note the voltage potentials can be EMG signals from muscle activation in the user's face or signals created by the friction of a sense electrode 123 sliding along the skin of the user's face as she changes expression.

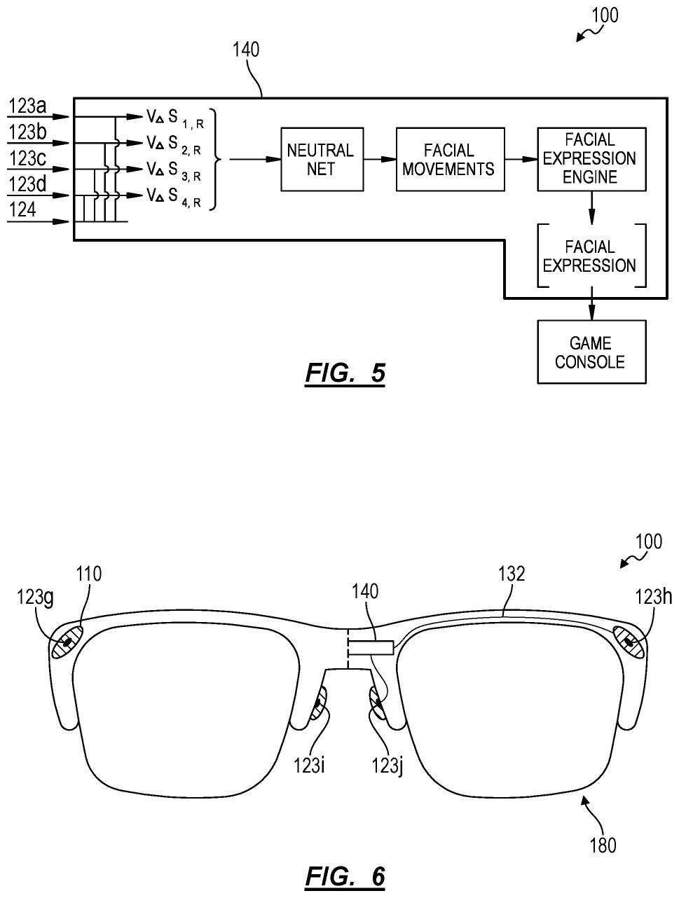

In one implementation shown in FIG. 5, the signal processing circuitry: filters sense and reference signals received from the sense electrodes 123 and reference electrodes 124; and outputs discrete digital values representative of a difference in voltage potential between a sense signal and the reference signals for each sense electrode 123 per sampling period. The signal processing circuitry can repeat this process for each sampling period, such as at a rate of 20 Hz. The controller 140 can then pass these current digital values, digital values recorded during preceding sampling periods, and/or temporal changes in these digital values occurring over multiple sampling periods into a neural network (e.g., a long short-term memory recurrent neural network calibrated to a user wearing the headset) that outputs a list (e.g., a matrix) of movements and magnitudes of these movements in various muscle groups on the user's face. The controller 140 can then pass this list of movements and magnitudes of these movements into a characterization engine to associate these movements with a facial expression, facial movement, or mouth movement, such as one of a: large smile; soft smile; impassive; frown; confusion; surprise; shame; focus; exhaustion; anger; fear; sadness; happiness; disgust; contempt; frustration; boredom; mouth open or opening; eyes closed, closing, or squinting; mouth closed or closing; and/or various mouth shapes.

The controller 140 can then return the facial expression, facial movement, or mouth movement identified during the current sampling period to the game console or any other processor or computational device, such as via a wired or wireless connection. The computation can then: project this facial expression, facial movement, or mouth movement onto a virtual avatar, such as by implementing a real-to-virtual expression mapping engine; update the virtual avatar within a virtual environment with this facial expression, facial movement, or mouth movement; generate a new frame representing the virtual environment and the virtual avatar; and serve this new frame to the headset for rendering on the display substantially in real-time.

Alternatively, the controller 140 can return the facial expression, such as a squint, to a processor in a pair of optical glasses, which may then adjust the opacity of the set of electrochromic lenses proportional to the degree to which the user is detected to be squinting. For example, if the squint detected by the controller 140 is subtle, the controller 140 may only slightly increase the opacity of the lenses. However, if the controller 140 detects that the user's eyes are almost entirely closed, the opacity of the glasses may be increased to a higher degree.

However, the controller 140 can implement any other methods or techniques to transform sense and reference signals from the sensor assembly 170 into facial expressions, facial movements, and/or mouth movements, etc. on the user's face.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A system comprising:
a sensor assembly comprising:
an elastic member:
configured to couple to a headset,
configured to contact a face of a user, proximal and offset from ocular regions of the face of the user, when the headset is worn by the user, and
comprising a compressible material configured to conform to the face of the user when the headset is worn by the user;
a substrate arranged across an exterior surface of the elastic member and defining a set of discrete electrical channels;
a set of electrode tabs distributed along the elastic member, each electrode tab:
configured to proximally contact a muscular region on the face of the user when the headset is worn by the user;
comprising a sense electrode defining an electrical contact surface facing outwardly from an interior surface of the elastic member opposite the substrate and configured to contact skin on the face of the user when the headset is worn by the user; and
comprising an enclosed trace extending from the sense electrode at the interior face of the elastic member to a discrete electrical channel, in the set of discrete electrical channels, at the exterior face of the elastic member; and
a controller configured to:
sample a set of sense signals from the set of electrode tabs via the set of discrete electrical channels; and
to interpret changes in the set of sense signals over time as expressions on the face of the user when the headset is worn by the user.

2. The system of claim 1, wherein the elastic member comprises a continuous elastic member extending along supraorbital regions and zygomatic regions of the face of the user and offset from ocular regions of the face of the user when the headset is worn by the user.

3. The system of claim 0, wherein the set of electrode tabs comprises:
a lower left electrode tab configured to proximally contact a left zygomaticus muscular region or a left levator labii superioris muscular region of the face of the user when the headset is worn by the user;
an upper left electrode tab configured to proximally contact a left upper orbicularis oculi muscular region of the face of the user when the headset is worn by the user;
a lower right electrode tab configured to proximally contact a right zygomaticus or a right levator labii superioris muscular region of the face of the user when the headset is worn by the user; and
an upper right electrode tab configured to proximally contact a right upper orbicularis oculi muscular region of the face of the user when the headset is worn by the user.

4. The system of claim 3, wherein the controller is further configured to output the expressions to a game console for representation on a virtual avatar in a virtual environment rendered on the headset.

5. The system of claim 4, wherein the elastic member is configured to transiently couple to the headset via a hook-and-loop attachment surface arranged over the substrate, the hook-and-loop attachment surface configured to align with a corresponding hook-and-loop attachment surface on the headset.

6. The system of claim 1:
wherein the elastic member is:
coupled to the headset, comprising a pair of optical glasses; and
configured to contact the face of the user, proximal to supraorbital regions of the face of the user and offset from ocular regions of the face of the user, when the headset is worn by the user; and
further comprising a second elastic member configured to contact a nasal bridge region of the face of the user and offset from ocular regions of the face of the user, when the headset is worn by the user; and
further comprising a second set of the electrode tabs distributed along the second elastic member; and
wherein the controller is configured to:
sample a second set of sense signals from the second set of electrode tabs; and
to interpret changes in the set of sense signals and the second set of sense signals over time as expressions on the face of the user when the headset is worn by the user.

7. The system of claim 6, wherein:
the set of electrode tabs comprises:
an upper left sense electrode coupled to the frame and configured to proximally contact a left upper orbicularis oculi muscular region of the face of the user when the headset is worn by the user; and
an upper right sense electrode coupled to the frame and configured to proximally contact a right upper orbicularis oculi muscular region of the face of the user when the headset is worn by the user; and
the second set of electrode tabs comprises:
a left nose pad sense electrode coupled to the internal surface of the nose pads of the headset and configured to proximally contact a left levator labii superioris alaeque nasi muscular region of the face of the user when the headset is worn by the user; and
a right nose pad sense electrode coupled to the internal surface of the nose pads of the headset and configured to proximally contact a right levator labii superioris alaeque nasi muscular region of the face of the user when the headset is worn by the user.

8. The system of claim 1, further comprising a reference electrode tab:
coupled to the elastic member;
configured to contact a low-muscle region on the face of the user when the headset is worn by the user;
comprising a reference electrode defining an electrical contact surface facing outwardly from an interior face of the elastic member opposite the substrate and configured to contact skin on the face of the user when the headset is worn by the user; and
electrically coupled to an electrical channel, in the set of electrical channels, defined on the substrate.

9. The system of claim 1, wherein each electrode tab in the set of electrode tabs comprises:
a base layer comprising a nonconductive polymer;
the sense electrode further comprising conductive ink deposited across a first surface of the base layer;
a junction pad comprising conductive ink deposited across the first surface of the base layer;
the enclosed trace further comprising:
an electrical trace comprising conductive ink deposited between the junction pad and the sense electrode across the first surface of the base layer; and
a nonconductive cover layer bonded to the base layer and enclosing the electrical trace between the nonconductive cover layer and the base layer.

10. The system of claim 9 wherein, for each electrode tab in the set of electrode tabs:
the base layer comprises thermoplastic polyurethane;
the conductive ink comprises silver ink; and
the sense electrode further comprises a silver chloride coating, preventing oxidation of the silver ink.

11. The system of claim 9, wherein, for each electrode tab in the set of electrode tabs:
the base layer is bonded to an interior surface of the substrate, the base layer interposed between the substrate and the elastic member, and the junction pad contacting a discrete electrical channel in the set of electrical channels on the substrate;
the base layer further defines a second surface, opposite the first surface of the base layer, that contacts an outer perimeter surface of the elastic member and is coupled to the interior surface of the elastic member; and
the sense electrode of each electrode tab in the set of electrode tabs faces outwardly from the first surface of the base layer and is configured to contact skin on the face of the user when the headset is worn by the user.

12. The system of claim 1, wherein the substrate and the electrode tabs form a unitary structure defining:
a substrate ring defining the set of discrete electrical channels and a common junction and conforming to the geometry of the elastic member;
for each electrode tab in the set of sense electrodes tabs, an electrode tab area defining the electrode tab and extending radially from a perimeter of the substrate ring; and
a cover layer covering the set of discrete electrical channels, the enclosed traces in the set of electrode tabs, and the common junction.

13. The system of claim 1, wherein:
the controller is arranged remote from the sensor assembly and connected to the sensor assembly via a common junction in the set of discrete electrical channels; and
the sensor assembly is replaceable with a second sensor assembly comprising:
a second elastic member:
configured to couple to a headset,
configured to contact a face of a user, proximal and offset from ocular regions of the face of the user, when the headset is worn by the user, and
comprising a compressible material configured to conform to the face of the user when the headset is worn by the user;
a second substrate arranged across an exterior surface of the second elastic member and defining a second set of discrete electrical channels and a second common junction of the second set of discrete electrical channels;
a second set of electrode tabs distributed along the second elastic member, each electrode tab:
configured to proximally contact a muscular region on the face of the user when the headset is worn by the user;
comprising a sense electrode defining an electrical contact surface facing outwardly from an interior surface of the second elastic member opposite the second substrate and configured to contact skin on the face of the user when the headset is worn by the user; and
comprising an enclosed trace extending from the sense electrode at the interior face of the second elastic member to a discrete electrical channel, in the second set of discrete electrical channels, at the exterior face of the second elastic member; and
the controller is configured to connect to the second sensor assembly via the second common junction of the second sensor assembly.

14. A manufacturing method comprising:
applying a layer of conductive ink to an exterior surface of a flexible substrate to form:
a set of sense electrodes;
a common junction; and
a set of electrical traces, each electrical trace connecting each sense electrode in the set of sense electrodes to a corresponding electrical channel of the common junction.
applying a non-oxidative conductive layer over the set of sense electrodes;
applying a nonconductive cover layer over the set of electrical traces;
selectively cutting the flexible substrate around the applied layer of conductive ink to define:
a substrate ring comprising the set of electrical traces and the common junction; and
a set of electrode tabs extending radially from the substrate ring, each electrode tab in the set of electrode tabs comprising a sense electrode in the set of sense electrodes;
assembling a sensor assembly by adhering:
an interior surface of the substrate ring to an exterior surface of an elastic member configured to conform to a face of a user offset from the ocular regions of the face of the user; and
an interior surface of each electrode tab in the set of electrode tabs to an interior surface of the elastic member; and
applying an adherent to an exterior surface of the sensor assembly, the adherent configured to transiently couple the sensor assembly to a view window of a virtual reality headset.

15. The manufacturing method of claim 14, further comprising:
electrically coupling the common junction to a virtual reality headset; and
adhering the exterior surface of the sensor assembly comprising the adherent to the view window of the virtual reality headset, the set of sense electrodes contacting the face of the user when the headset is worn by the user.

16. The manufacturing method of claim 14, wherein applying the adherent to an exterior surface of the sensor assembly further comprises applying a hook-and-loop attachment surface to the exterior surface of the sensor assembly, the hook-and-loop attachment surface configured to transiently couple to a corresponding hook-and-loop attachment surface around the view window of the virtual reality headset.

17. The manufacturing method of claim 14, wherein:
applying the layer of conductive ink to the flexible substrate comprises applying a layer of silver ink to thermoplastic polyurethane;
applying the non-oxidative conductive layer over the set of sense electrodes comprises applying a layer of silver chloride over the set of sense electrodes; and
applying the nonconductive cover layer over the set of electrical traces and the common junction comprises applying a layer of thermoplastic polyurethane over the set of electrical traces and the common junction.

18. A manufacturing method comprising:
applying a layer of conductive ink to an exterior surface of a flexible substrate to form:
a common junction;
a set of electrical pads; and
a set of electrical channels, each electrical channel connecting each electrical pad in the set of electrical pads to a corresponding electrical channel of the common junction;
selectively cutting the flexible substrate around the applied layer of conductive ink to define a substrate ring comprising the set of electrical pads, the set of electrical channels, and the common junction;
applying a layer of conductive ink to a flexible polymer sheet to form a set of electrode tabs, each electrode tab comprising:
a junction pad;
a sense electrode; and
an electrical trace connecting the junction pad and the sense electrode;
for each electrode tab in the set of electrode tabs, separating the electrode tab from the flexible polymer sheet;
assembling an electrode-substrate assembly by adhering, for each electrode tab in the set of electrode tabs, the junction pad of the electrode tab to an electrical pad in the set of electrical pads on the substrate ring;
assembling a sensor assembly by adhering:
an interior surface of the substrate ring of the electrode-substrate assembly to an exterior surface of an elastic member configured to conform to a face of a user offset from the ocular regions of the face of the user; and
an interior surface of each electrode tab in the set of electrode tabs to an interior surface of the elastic member; and
applying an adherent to an exterior surface of the sensor assembly, the adherent configured to transiently couple the sensor assembly to a view window of a virtual reality headset.

19. The manufacturing method of claim 18, further comprising:
electrically coupling the common junction to the virtual reality headset; and
adhering an exterior surface of the sensor assembly comprising the adherent around the view window of the virtual reality headset, the set of sense electrodes contacting the face of the user when the headset is worn by the user.

20. The manufacturing method of claim 18, further comprising applying a layer of silver chloride to the sense electrode to prevent oxidation of the electrical contact surface.
